(19) United States
(12) Patent Application Publication
(10) Pub. No.: US 2017/0059247 A1
(43) Pub. Date: Mar. 2, 2017

(54) HEAT TREATMENT DEVICE

(71) Applicants: IHI Corporation, Tokyo (JP); IHI Machinery and Furnace Co., Ltd., Tokyo (JP)

(72) Inventors: Kazuhiko KATSUMATA, Inuyama-shi (JP); Kaoru ISOMOTO, Tokyo (JP); Takahiro NAGATA, Kamo-gun (JP); Akira Nakayama, Hikari-shi (JP); Yuusuke SHIMIZU, Gifu-shi (JP); Gen Nishitani, Kakamigahara-shi (JP)

(73) Assignees: IHI Corporation, Tokyo (JP); IHI Machinery and Furnace Co., Ltd., Tokyo (JP)

(21) Appl. No.: 15/350,692

(22) Filed: Nov. 14, 2016

Related U.S. Application Data
(63) Continuation of application No. PCT/JP2015/068845, filed on Jun. 30, 2015.

(30) Foreign Application Priority Data
Jul. 7, 2014 (JP) 2014-139629

(51) Int. Cl. F27B 5/10; F27D 11/02; F27B 5/14

(52) U.S. Cl. CPC F27B 5/10; F27B 5/14; F27D 11/02

(57) ABSTRACT

A heat treatment device includes: a heating chamber inside which a treatment object is contained; a lower heater that heats the lower section of a receiving area that is an area inside the heating chamber in which the treatment object is contained; and an upper heater that heats the upper section of the receiving area.

### CROSS-REFERENCE TO RELATED APPLICATIONS

This application is a Continuation Application based on International Application No. PCT/JP2015/068845, filed Jun. 30, 2015, which claims priority on Japanese Patent Application No. 2014-139629, filed Jul. 7, 2014, the contents of which are incorporated herein by reference.

### TECHNICAL FIELD

The present disclosure relates to a heat treatment device.

### BACKGROUND

As a heat treatment device that performs heating treatment for a metal material serving as a treatment object, a multi-chamber heat treatment device is known (for example, refer to Patent Document 1). The multi-chamber heat treatment device includes a heating chamber in which the treatment object is contained, and a heater provided inside the heating chamber heats the treatment object, whereby the heating treatment is performed.

Patent Documents 2 to 4 disclose devices that include heating chambers and heaters and perform heating treatment or baking for a treatment object.

### DOCUMENT OF RELATED ART

### Patent Document

[Patent Document 1] Japanese Unexamined Patent Application, First Publication No. 2012-13341

[Patent Document 2] PCT International Publication No. 2006/013932

[Patent Document 3] Japanese Unexamined Patent Application, First Publication No. 2002-228364

[Patent Document 4] Published Japanese Translation No. 2009-543996

### SUMMARY

### Technical Problem

In general, the inner wall of the heating chamber is provided with a thermal insulator in order to prevent heat of the heater from escaping out of the heating chamber. However, since the bottom of the heating chamber is provided with a mounting table having a large heat capacity on which the treatment object is mounted and with pipes or the like provided so as to penetrate the thermal insulator, heat easily escapes out of the heating chamber. Therefore, non-uniformity in temperature may occur inside the heating chamber, for example, the temperature of the lower side of the heating chamber may become lower than that of the upper side thereof. If such non-uniformity in temperature occurs, variation in the heat treatment condition may occur, which may cause deterioration in the quality of the treatment object.

The present disclosure has been made in view of the above problems, and an object thereof is in a heat treatment device that performs heating treatment for a treatment object, to limit occurrence of non-uniformity in temperature inside a heating chamber and to uniformly heat the treatment object.

### Solution to Problem

The present disclosure includes the following configurations serving as means of solving the above problems.

A first aspect of the present disclosure is a heat treatment device for performing heating treatment for a treatment object, the heat treatment device including: a heating chamber inside which the treatment object is contained; a lower heater that heats a lower section of a receiving area that is an area inside the heating chamber in which the treatment object is contained; and an upper heater that heats an upper section of the receiving area.

A second aspect of the present disclosure is the heat treatment device of the first aspect including a thermal conduction barrier wall disposed between the receiving area and the lower and upper heaters.

A third aspect of the present disclosure is that in the heat treatment device of the first or second aspect, the upper heater includes upper heaters that are electric heaters, and the lower heater includes lower heaters that are electric heaters. In addition, the heat treatment device includes: an upper heater-power supplier that supplies electric power to all the upper heaters; and a lower heater-power supplier that supplies electric power to all the lower heaters.

A fourth aspect of the present disclosure is that in the heat treatment device of the first aspect, the lower heater includes: a pair of lower heater bodies extending in the vertical direction, and a lower heater-connecting part connecting end parts of the lower heater bodies to each other. In addition, the upper heater includes: a pair of upper heater bodies extending in the vertical direction, and an upper heater-connecting part connecting end parts of the upper heater bodies to each other.

A fifth aspect of the present disclosure is that in the heat treatment device of the fourth aspect, the lower and upper heaters are electric heaters. The lower heater-connecting part has electrical conductivity and is configured to allow electricity to flow from one to the other of the lower heater bodies, and the upper heater-connecting part has electrical conductivity and is configured to allow electricity to flow from one to the other of the upper heater bodies. One of the lower heater bodies is provided with an entry-side terminal for electric power, and the other of the lower heater bodies is provided with an exit-side terminal for electric power. In addition, one of the upper heater bodies is provided with an entry-side terminal for electric power, and the other of the upper heater bodies is provided with an exit-side terminal for electric power.

Effects

A heat treatment device of the present disclosure includes a lower heater that heats the lower section of a receiving area inside a heating chamber and an upper heater that heats the upper section of the receiving area, and a treatment object is contained in the receiving area. Therefore, according to the present disclosure, it is possible to individually control the temperatures of the lower and upper sections of the receiving area. Consequently, when the temperature of the lower section of the receiving area is lower than that of the upper section thereof, only the output of the lower heater is increased, whereby the internal temperature of the receiving area can be uniformized. Thus, according to the present disclosure, in the heat treatment device that performs heating treatment for the treatment object, it is possible to limit occurrence of non-uniformity in temperature inside the heating chamber (the receiving area) and to uniformly heat the treatment object.

### BRIEF DESCRIPTION OF DRAWINGS

FIG. 1 is a vertical cross-sectional view showing a schematic configuration of a heat treatment device of a first embodiment of the present disclosure.

FIG. 2 is a view taken along A-A line in FIG. 1 and showing a wire-connecting state between a wire-connecting entry-side section of a lower heater-power supplier and lower heaters through heat-resistant electrical wires and a wire-connecting state between a wire-connecting entry-side section of an upper heater-power supplier and upper heaters through heat-resistant electrical wires.

FIG. 3 is a view taken along A-A line in FIG. 1 and showing a wire-connecting state between a wire-connecting exit-side section of the lower heater-power supplier and the lower heaters through heat-resistant electrical wires and a wire-connecting state between a wire-connecting exit-side section of the upper heater-power supplier and the upper heaters through heat-resistant electrical wires.

FIG. 4A is a wiring diagram showing a wire-connecting state between the lower heater-power supplier and the lower heaters through heat-resistant electrical wires.

FIG. 4B is a wiring diagram showing a wire-connecting state between the upper heater-power supplier and the upper heaters through heat-resistant electrical wires.

FIG. 5 is a vertical cross-sectional view showing a schematic configuration of a heat treatment device of a second embodiment of the present disclosure.

FIG. 6 is a development side view of heaters disposed inside a heating chamber of the heat treatment device.

FIG. 7 is a view taken along B-B line in FIG. 5 and showing a wire-connecting state between a wire-connecting entry-side section of a lower heater-power supplier and lower heaters through heat-resistant electrical wires and a wire-connecting state between a wire-connecting entry-side section of an upper heater-power supplier and upper heaters through heat-resistant electrical wires.

FIG. 8 is a view taken along B-B line in FIG. 5 and showing a wire-connecting state between a wire-connecting exit-side section of the lower heater-power supplier and the lower heaters through heat-resistant electrical wires and a wire-connecting state between a wire-connecting exit-side section of the upper heater-power supplier and the upper heaters through heat-resistant electrical wires.

FIG. 9 is a wiring diagram showing a wire-connecting state between the lower heater-power supplier and the lower heaters through heat-resistant electrical wires and a wire-connecting state between the upper heater-power supplier and the upper heaters through heat-resistant electrical wires.

### DESCRIPTION OF EMBODIMENTS

Hereinafter, heat treatment devices of the present disclosure are described with reference to the drawings. In the following drawings, the scale of each member is appropriately changed in order to show each member in a recognizable size.

### First Embodiment

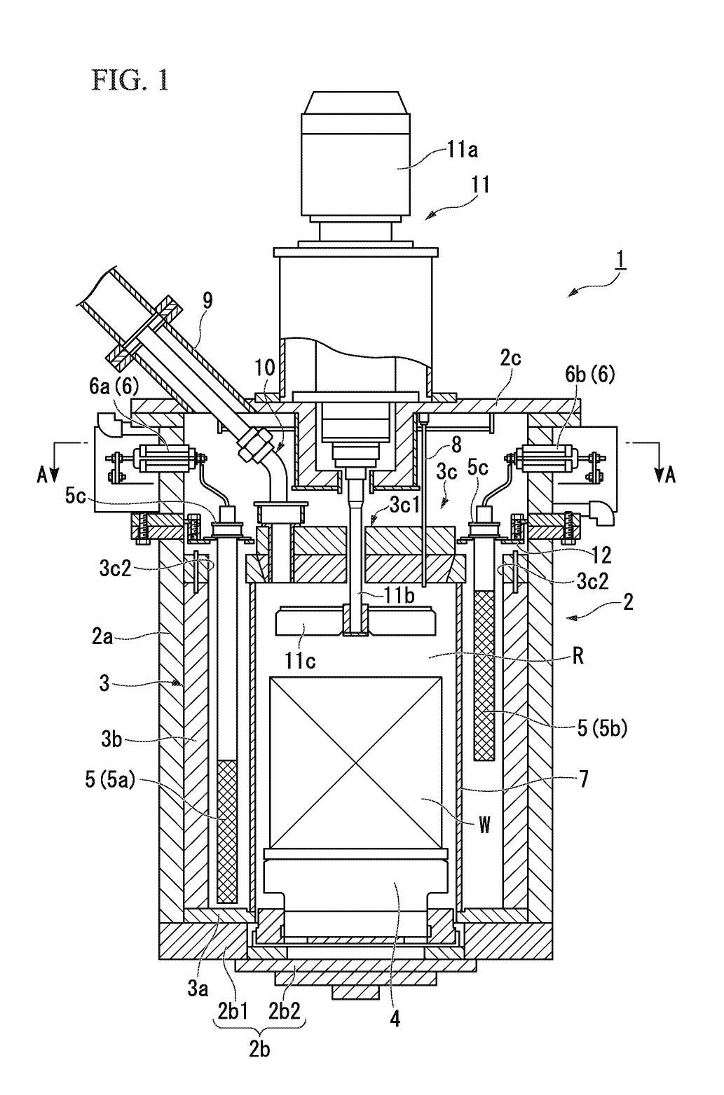

FIG. 1 is a vertical cross-sectional view showing a schematic configuration of a heat treatment device 1 of a first embodiment of the present disclosure. The upper side of FIG. 1 shows the upper side of the device in the vertical direction. The heat treatment device 1 of this embodiment is a device that performs heating treatment for a treatment object W and as shown in FIG. 1, includes a heating chamber 2, a thermal insulator 3, a mounting table 4, heaters 5, a power supplier 6, a maffle plate 7 (a thermal conduction barrier wall), a gas supplier 8, a first exhaust pipe 9, a second exhaust pipe 10 and a stirrer 11.

The heating chamber 2 is a vertically placed container that is formed into an approximately cylindrical shape and whose central axis extends in the vertical direction. The treatment object W is accommodated inside the heating chamber 2. That is, the inside of the heating chamber 2 is provided with a receiving area R in which the treatment object W is contained. In the heating chamber 2, an approximately cylindrical side wall portion 2a is provided with a bottom portion 2b and a lid portion 2c, whereby the inside of the heating chamber 2 becomes a closed space. The thermal insulator 3, the mounting table 4, the heaters 5, the maffle plate 7 and the like are accommodated in the closed space, namely the inside of the heating chamber 2.

The bottom portion 2b includes a circular annular bottom frame 2b1 and a bottom body 2b2 that is detachably attached to a central opening of the bottom frame 2b1 and air-tightly closes the central opening. The bottom body 2b2 is detachably attached to the bottom frame 2b1 using fastening screws or the like. The bottom body 2b2 is formed and disposed so as to contact the bottom frame 2b1. The bottom body 2b2 functions as an opening-and-closing member (an opening-and-closing door) used for loading and unloading the treatment object W into and from the inside of the heating chamber 2.

The thermal insulator 3 includes a lower thermal insulator 3a, a side thermal insulator 3b and an upper thermal insulator 3c.

The lower thermal insulator 3a is formed into a circular annular shape provided on the top of the bottom frame 2b1. The side thermal insulator 3b is attached to the inner wall of the side wall portion 2a of the heating chamber 2. That is, the side thermal insulator 3b is also formed into a cylindrical shape. The upper thermal insulator 3c is disposed on the inner side of the lid portion 2c of the heating chamber 2 (that is, is disposed under the lid portion 2c). The upper thermal insulator 3c includes a lid 3c1 detachably provided in the central part of the upper thermal insulator 3c and though-holes 3c2 disposed around the lid 3c1, and the heaters 5 are inserted into the through-holes 3c2. Since twelve heaters 5 are provided in this embodiment as described below, twelve through-holes 3c2 are annularly disposed around the lid 3c1. The thermal insulator 3 may be formed by overlapping a thermal insulation material and a ceramic board with each other, and the thermal insulation material is formed of, for example, a ceramic fiber board.

The mounting table 4 is disposed on the top of the bottom body 2b2, and the treatment object W is placed on the mounting table 4. When the bottom body 2b2 is detached from the bottom frame 2b1, the mounting table 4 is moved together with the bottom body 2b2 and is taken out of the heating chamber 2.

The heaters 5 are electric heaters that generate heat by being energized. In this embodiment, the heaters 5 include lower heaters 5a that have long bodies extending in the vertical direction and upper heaters 5b that have short bodies extending in the vertical direction. A lower end portion (a portion including the lower end) of the body of the lower heater 5a is a heat-generating area, and the lower heater 5a heats the lower section of the receiving area R for the treatment object W. A lower end portion (a portion including the lower end) of the body of the upper heater 5a is a heat-generating area, and the upper heater 5a heats the upper section of the receiving area R for the treatment object W.

The upper parts of the heaters 5 are provided with flanges 5c. An annular supporting member 12 disposed above the upper thermal insulator 3c (in detail, the part of the upper thermal insulator 3c in which the through-holes 3c2 are formed) is fixed to the side wall portion 2a, and the flanges 5c are supported by the supporting member 12, whereby the heaters 5 are suspended and supported. The supporting member 12 may be fixed to the side wall portion 2a so as to be detachable therefrom. The heaters 5 are inserted through the through-holes 3c2 from above the thermal insulator 3 into the space enclosed by the thermal insulator 3. That is, the lower heaters 5a and the upper heaters 5b of this embodiment are provided so as to extend downward from the supporting member 12. Since the lower heater 5a is longer than the upper heater 5b, the lower end of the lower heater 5a is positioned below the lower end of the upper heater 5b. The upper end of the lower heater 5a of this embodiment is provided with a positive terminal serving as an entry-side terminal for electric power and a negative terminal serving as an exit-side terminal for electric power. The upper end of the upper heater 5b of this embodiment is provided with a positive terminal serving as an entry-side terminal for electric power and a negative terminal serving as an exit-side terminal for electric power.

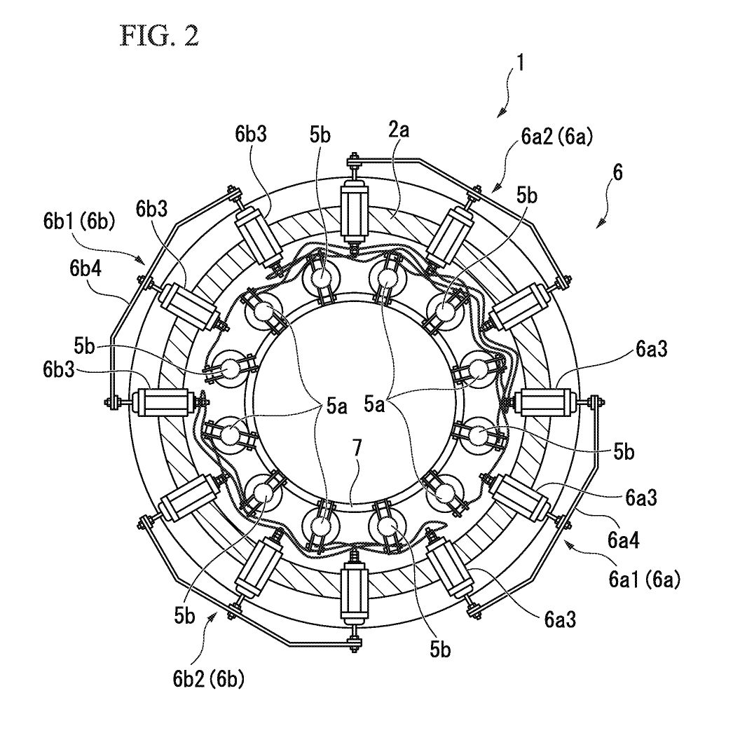

FIG. 2 is a view taken along A-A line in FIG. 1. As shown in FIG. 2, the twelve heaters 5 of this embodiment are disposed into an annular shape (an annular shape in plan view) around the receiving area R for the treatment object W at regular intervals. That is, the twelve heaters 5 are arranged in the circumferential direction of the heating chamber 2 (the side wall portion 2a). In this embodiment, the lower heaters 5a and the upper heaters 5b are alternately arranged in the circumferential direction, and six lower heaters 5a and six upper heaters 5b are provided.

The power supplier 6 is a device that supplies electric power to the heaters 5 and is connected to each heater 5 through a heat-resistant electrical wire. In this embodiment, the power supplier 6 includes a lower heater-power supplier 6a and an upper heater-power supplier 6b. The power supplier 6 may further include a power supply controller (not shown) that can output intended electric power. The lower heater-power supplier 6a is configured to supply electric power to all the lower heaters 5a and is formed of a wire-connecting entry-side section 6a1 and a wire-connecting exit-side section 6a2. The upper heater-power supplier 6b is configured to supply electric power to all the upper heaters 5b and is formed of a wire-connecting entry-side section 6b1 and a wire-connecting exit-side section 6b2.

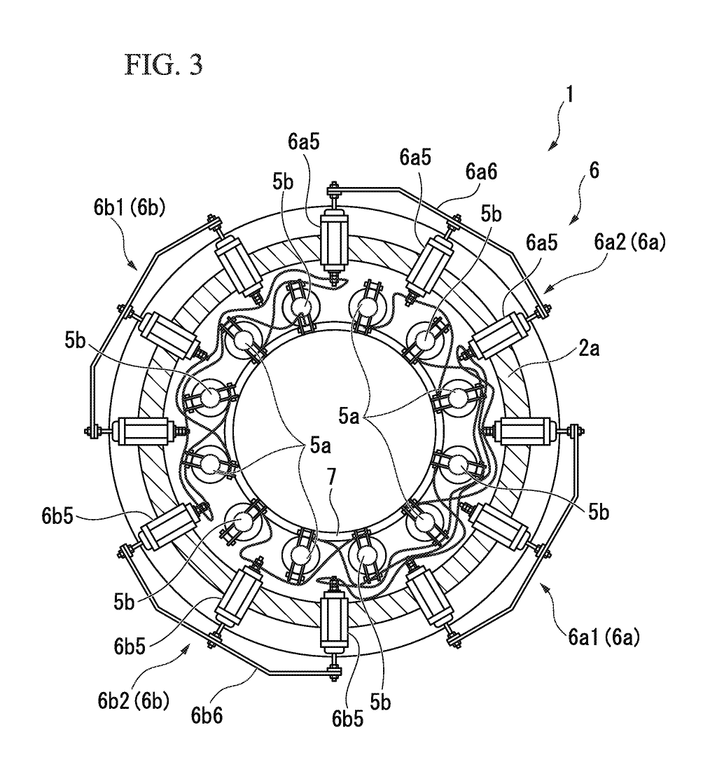

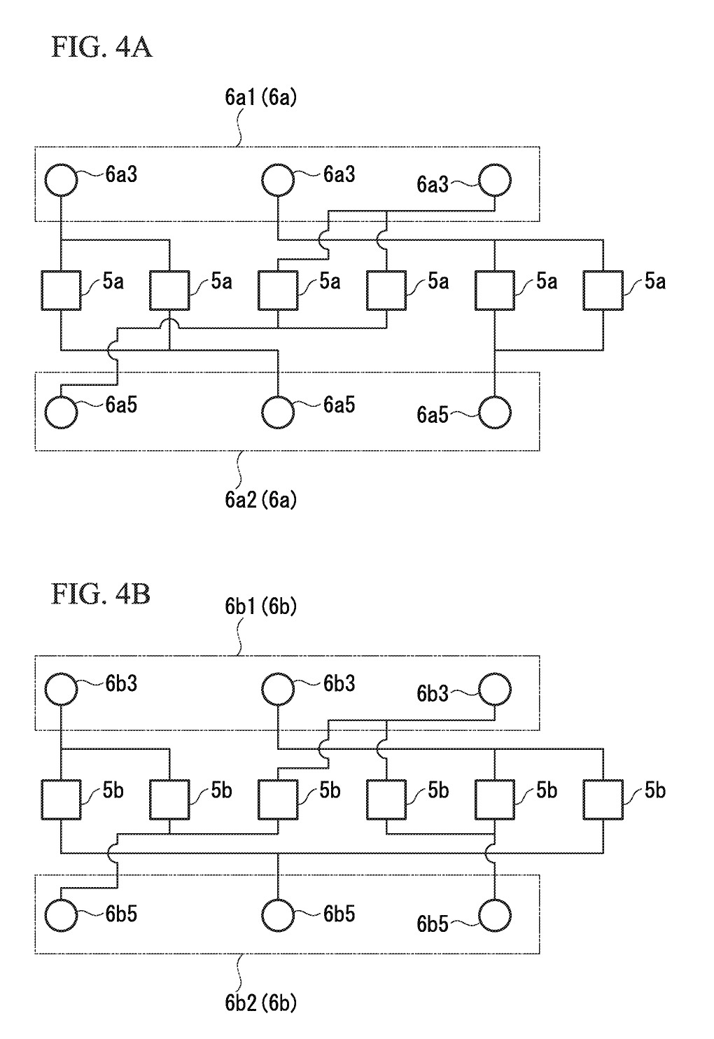

Each of FIGS. 2 and 3 is a view taken along A-A line in FIG. 1. It is to be noted that FIG. 2 shows a wire-connecting state between the wire-connecting entry-side section 6a1 of the lower heater-power supplier 6a and the lower heaters 5a through heat-resistant electrical wires and a wire-connecting state between the wire-connecting entry-side section 6b1 of the upper heater-power supplier 6b and the upper heaters 5b through heat-resistant electrical wires, and FIG. 3 shows a wire-connecting state between the wire-connecting exit-side section 6a2 of the lower heater-power supplier 6a and the lower heaters 5a through heat-resistant electrical wires and a wire-connecting state between the wire-connecting exit-side section 6b2 of the upper heater-power supplier 6b and the upper heaters 5b through heat-resistant electrical wires. FIG. 4A is a wiring diagram showing a wire-connecting state between the lower heater-power supplier 6a and the lower heaters 5a through heat-resistant electrical wires, and FIG. 4B is a wiring diagram showing a wire-connecting state between the upper heater-power supplier 6b and the upper heaters 5b through heat-resistant electrical wires.

As shown in FIGS. 2 and 4A, the wire-connecting entry-side section 6a1 includes three electrode bars 6a3 and a bus bar 6a4 connecting the electrode bars 6a3. The bus bar 6a4 is connected to each of the three electrode bars 6a3. Each of the three electrode bars 6a3 is connected to the positive terminals of two lower heaters 5a through heat-resistant electrical wires. As shown in FIGS. 3 and 4B, the wire-connecting exit-side section 6a2 includes three electrode bars 6a5 and a bus bar 6a6 connecting the electrode bars 6a5. The bus bar 6a6 is connected to each of the three electrode bars 6a5. Each of the three electrode bars 6a5 is connected to the negative terminals of two lower heaters 5a through heat-resistant electrical wires. The bus bars 6a4 and 6a6 may be connected with a power supply controller (a first power supply controller, not shown) that can output intended electric power, and thus the lower heater-power supplier 6a may be configured to supply electric power to the lower heaters 5a and to allow the lower heaters 5a to generate heat.

As shown in FIGS. 2 and 4A, the wire-connecting entry-side section 6b1 includes three electrode bars 6b3 and a bus bar 6b4 connecting the electrode bars 6b3. The bus bar 6b4 is connected to each of the three electrode bars 6b3. Each of the three electrode bars 6b3 is connected to the positive terminals of two upper heaters 5b through heat-resistant electrical wires. As shown in FIGS. 3 and 4B, the wire-connecting exit-side section 6b2 includes three electrode bars 6b5 and a bus bar 6b6 connecting the electrode bars 6b5. The bus bar 6b6 is connected to each of the three electrode bars 6b5. Each of the three electrode bars 6b5 is connected to the negative terminals of two upper heaters 5b through heat-resistant electrical wires. The bus bars 6b4 and 6b6 may be connected with a power supply controller (a second power supply controller, not shown) that can supply intended electric power, and thus the upper heater-power supplier 6b may be configured to supply electric power to the upper heaters 5b and to allow the upper heaters 5b to generate heat.

Returning to FIG. 1, the maffle plate 7 is a cylindrical member that is disposed along the side wall portion 2a with a constant gap therebetween so that the central axis of the maffle plate 7 is positioned at approximately the same position as that of the central axis of the side wall portion 2a, and is formed of a refractory having excellent thermal conductivity. The maffle plate 7 is provided at a position closer to the center of the heating chamber 2 than the heaters 5, and an arrangement space for the heaters 5 is formed between the maffle plate 7 and the side wall portion 2a. The upper thermal insulator 3c is disposed on the upper end of the maffle plate 7. The upper end of the maffle plate 7 of this embodiment contacts the lower surface of the upper thermal insulator 3c, and the lower end of the maffle plate 7 contacts the top surface of the lower thermal insulator 3a. A space surrounded by the maffle plate 7 serves as the receiving area R in which the treatment object W is contained during heating treatment. That is, the maffle plate 7 is disposed between the receiving area R and the lower and upper heaters 5a and 5b.

The gas supplier 8 is a device that is provided so as to penetrate the lid portion 2c and is connected to a supply source (not shown) of atmosphere-forming gas (for example, hydrocarbon gas) through a pipe (not shown) at an outer area of the lid portion 2c. The end part (the lower end part) of the gas supplier 8 penetrates the lid 3c1 of the upper thermal insulator 3c, and the end of the gas supplier 8 is disposed in the receiving area R.

The first exhaust pipe 9 is arranged so as to diagonally extend upward and radially outward from the lid portion 2c and is disposed communicating with a space between the lid portion 2c and the upper thermal insulator 3c, and the end (the end opposite to the lid portion 2c) of the first exhaust pipe 9 is connected to a vacuum pump (not shown). The second exhaust pipe 10 is inserted into the first exhaust pipe 9 so that the end (the end opposite to the upper thermal insulator 3c) of the second exhaust pipe 10 is positioned at the middle of the first exhaust pipe 9. The second exhaust pipe 10 is provided so as to penetrate the lid portion 2c and the lid 3c1 of the upper thermal insulator 3c and to communicate with the receiving area R. The outer diameter of part of the second exhaust pipe 10 positioned close to the first exhaust pipe 9 is formed to be sufficiently less than the inner diameter of the first exhaust pipe 9, and thereby the second exhaust pipe 10 is configured not to close the first exhaust pipe 9. The first and second exhaust pipes 9 and 10 are connected to the vacuum pump and are configured to forcibly exhaust the inside of the heating chamber 2 using the vacuum pump.

The stirrer 11 is fixed to the lid portion 2c, and includes a drive portion 11a formed of a motor or the like, and a stirring blade 11c attached to the drive portion 11a through a drive shaft 11b to be positioned under the drive portion 11a. The drive shaft 11b is disposed so as to penetrate the lid 3c1 of the upper thermal insulator 3c. The stirring blade 11c is attached to the lower end part of the drive shaft 11b and thereby is disposed in an upper area inside the receiving area R. The stirrer 11 stirs gas inside the receiving area R through rotational motion of the stirring blade 11c and thus uniformizes the temperature or the gas concentration inside the receiving area R.

The heat treatment device 1 is provided with thermocouples (a temperature-measuring device, not shown) that measure the temperatures of upper and lower sections into which the inside of the receiving area R is divided in the vertical direction, and thereby it is possible to measure the temperatures of the upper and lower sections of the receiving area R. The thermocouples may be electrically connected to the power supplier 6 (or to the first and second power supply controllers), and may be configured to output results of temperature measurement to the power supplier 6 or the like.

When the heat treatment device 1 performs heating treatment, first, the treatment object W is set on the mounting table 4 and is disposed inside the heating chamber 2. Next, the power supplier 6 energizes the heaters 5, and thereby the receiving area R is heated to an intended temperature. The vacuum pump (not shown) is operated, and thereby the heating chamber 2 is depressurized through the first and second exhaust pipes 9 and 10. The depressurization of the heating chamber 2 may be performed before the energization for the heaters 5.

Then, when the heating chamber 2 has a depressurized atmosphere having an intended temperature, the stirrer 11 is driven, thereby the stirring blade 11c is rotated, the gas supplier 8 supplies the atmosphere-forming gas thereto as needed, and heating treatment is performed on the treatment object W. At this time, for example, when the temperature of the lower section of the receiving area R proves to be lower than that of the upper section thereof based on the results of temperature measurement of the thermocouples, electric power supplied from the power supplier 6 is increased, and thereby the quantity of generated heat of the lower heaters 5a is increased compared to that of the upper heaters 5b. Accordingly, the quantity of heat applied to the lower section of the receiving area R is increased, and thus it is possible to uniformize the temperature of the receiving area R. Adjustments of electric power value in this way may be performed by the above-described power supply controller (the first and second power supply controllers).

Although soot or the like is produced at the receiving area R when such heating treatment is performed, since the receiving area R is surrounded by the maffle plate 7, soot or the like does not substantially attach to the heaters 5. That is, it is possible to maintain the heaters 5 in appropriate condition for a long period of time, and to increase each length of maintenance intervals for the heaters 5.

After the heating treatment is performed for a predetermined period of time, the heating using the heaters 5 is stopped.

Then, the depressurization using the vacuum pump is also stopped, and the treatment object W is unloaded from the inside of the heating chamber 2. Thereafter, a new treatment object W is set inside the heating chamber 2, the above operations are repeated, and thereby the heating treatment can also be performed on the new treatment object W.

The heat treatment device 1 of this embodiment having the above configuration includes the lower heaters 5a that heat the lower section of the receiving area R inside the heating chamber 2, and the lower heaters 5a that heat the upper section thereof. Therefore, according to the heat treatment device 1 of this embodiment, it is possible to individually control the temperatures of the lower and upper sections of the receiving area R. When the temperature of the lower section of the receiving area R is lower than that of the upper section thereof, it is possible to uniformize the internal temperature of the receiving area R by increasing only the output of the lower heaters 5a. Thus, according to the heat treatment device 1 of this embodiment, it is possible to limit non-uniformity in temperature of the inside (the receiving area R) of the heating chamber 2, and to uniformly heat the treatment object W.

The heat treatment device 1 of this embodiment includes the maffle plate 7 disposed between the storage area R and the lower and upper heaters 5a and 5b. Therefore, heat radiated from the lower and upper heaters 5a and 5b is conducted through the maffle plate 7 and is spread in the up-and-down direction (and in the circumferential direction). Consequently, it is possible to further uniformly heat the treatment object W. In addition, since the maffle plate 7 covers the receiving area R, it is possible to prevent soot, or the like, produced at the receiving area R from attaching to the heaters 5.

In the heat treatment device 1 of this embodiment, the heaters 5 are electric heaters, and the heat treatment device 1 includes the lower heater-power supplier 6a that supplies electric power to all the lower heaters 5a, and the upper heater-power supplier 6b that supplies electric power to all the upper heaters 5b. Therefore, the lower heater-power supplier 6a can perform temperature adjustment of all the lower heaters 5a. In addition, the upper heater-power supplier 6b can perform temperature adjustment of all the upper heaters 5b.

Consequently, the heat treatment device 1 of this embodiment can easily and correctly perform temperature control of the heaters 5.

### Second Embodiment

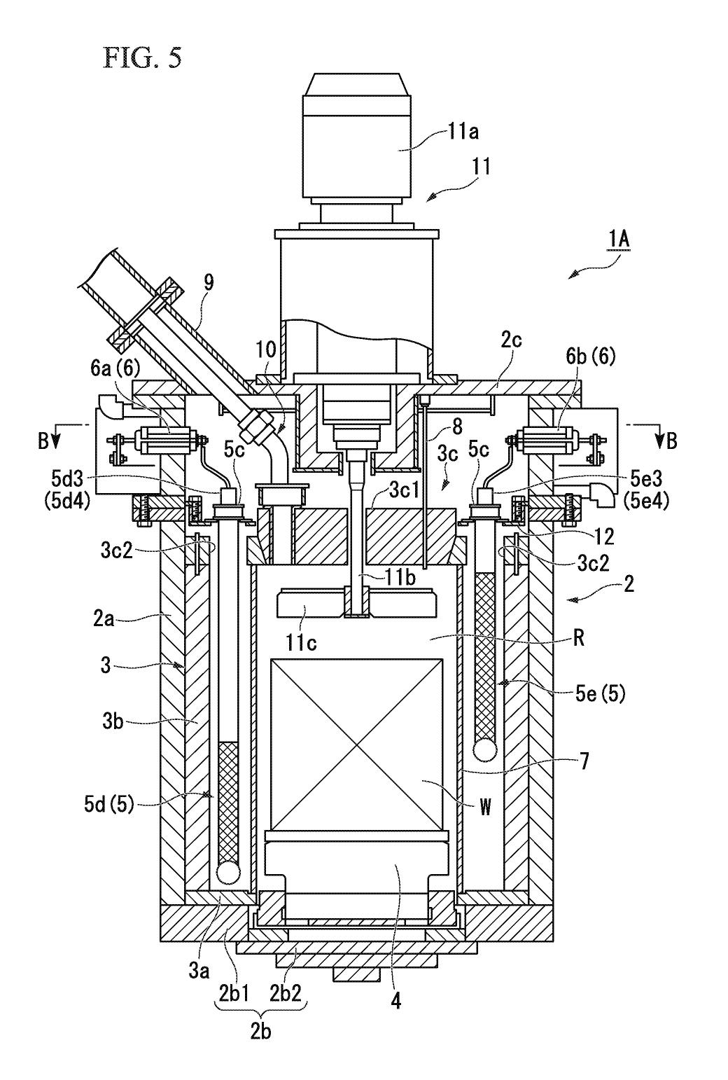

Hereinafter, a heat treatment device of a second embodiment of the present disclosure is described with reference to FIGS. 5 to 9. In this embodiment, a component having approximately the same structure and function as those of a component of the first embodiment is attached with the same reference sign as that of the component of the first embodiment, and duplicate descriptions may be omitted.

FIG. 5 is a vertical cross-sectional view showing a schematic configuration of a heat treatment device 1A of the second embodiment of the present disclosure. The upper side of FIG. 5 shows the upper side of the device in the vertical direction. Although the heat treatment device 1A includes a plurality of heaters 5 similar to those of the first embodiment, the heaters 5 of this embodiment includes a plurality of lower heaters 5d and a plurality of upper heater 5e instead of the lower and upper heaters 5a and 5b of the first embodiment.

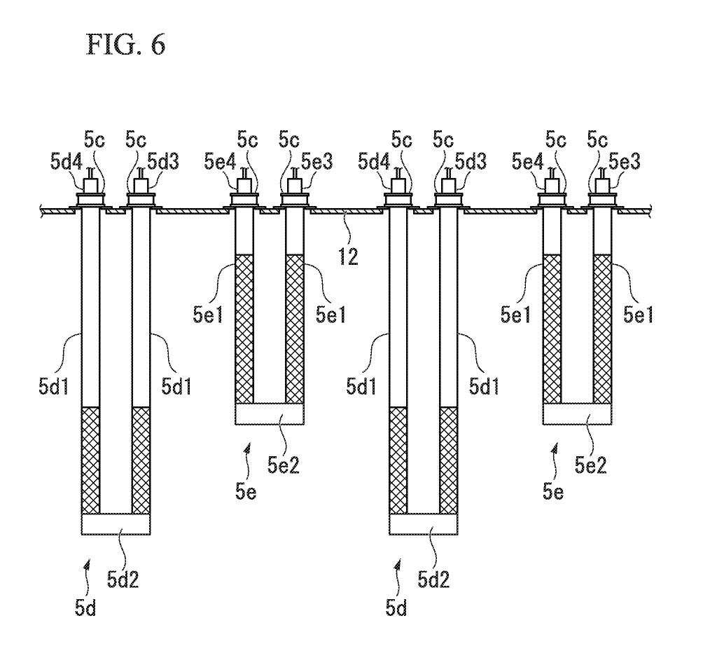

FIG. 6 is a development side view of the heaters 5 (the lower and upper heaters 5d and 5e) disposed inside a heating chamber 2 of the heat treatment device 1A. Each of the lower and upper heaters 5d and 5e is formed into an approximate U-shape, and the upper part of each heater is fixed to a supporting member 12. The lower and upper heaters 5d and 5e are provided so as to extend downward from the supporting member 12. The length of the lower heater 5d in the vertical direction is set to be greater than the length of the upper heater 5e in the vertical direction.

The lower heater 5d includes a pair of lower heater bodies 5d1 extending in the vertical direction and a lower heater-connecting part 5d2 connecting the lower end parts (the end parts) of the lower heater bodies 5d1 to each other, and the entire lower heater 5d is formed into an approximate U-shape. The lower heater body 5d1 is formed into a rod shape extending in the vertical direction, and the lower heater-connecting part 5d2 is formed into a rod shape extending in a horizontal direction. The lower heater 5d is an electric heater. That is, the lower heater bodies 5d1 are electric heaters and are configured to generate heat by being energized. A portion (a portion attached with cross-hatching in FIGS. 5 and 6) including the lower end of the lower heater body 5d1 is a heat-generating area and heats the lower section of a receiving area R. The upper end part of one of the lower heater bodies 5d1 is provided with a positive terminal 5d3 serving as an entry-side terminal for electric power, and the upper end part of the other of the lower heater bodies 5d1 is provided with a negative terminal 5d4 serving as an exit-side terminal for electric power. That is, unlike the above first embodiment, the lower heater body 5d1 of this embodiment is provided with only one of the positive terminal 5d3 and the negative terminal 5d4. The lower heater-connecting part 5d2 has electrical conductivity and is configured to allow electricity to flow from one to the other of the lower heater bodies 5d1. Thus, when electric power is supplied to the positive terminal 5d3 of the lower heater 5d, each of the lower heater bodies 5d1 can generate heat. The lower heater-connecting part 5d2 may be formed only of an electrically conductive material, or may have a structure in which an electrically conductive material (an electrical wire) is covered with an electrical insulation material.

The upper heater 5e includes a pair of upper heater bodies 5e1 extending in the vertical direction and a upper heater-connecting part 5e2 connecting the lower end parts (the end parts) of the upper heater bodies 5e1 to each other, and the entire upper heater 5e is formed into an approximate U-shape. The upper heater body 5e1 is formed into a rod shape extending in the vertical direction, and the upper heater-connecting part 5e2 is formed into a rod shape extending in a horizontal direction. The upper heater 5e is also an electric heater similar to the lower heater 5d. That is, the upper heater bodies 5e1 are electric heaters and are configured to generate heat by being energized. A portion (a portion attached with cross-hatching in FIGS. 5 and 6) including the lower end of the upper heater body 5e1 is a heat-generating area and heats the upper section of the receiving area R. The upper end part of one of the upper heater bodies 5e1 is provided with a positive terminal 5e3 serving as an entry-side terminal for electric power, and the upper end part of the other of the upper heater bodies 5e1 is provided with a negative terminal 5e4 serving as an exit-side terminal for electric power. That is, unlike the above first embodiment, the upper heater body 5e1 of this embodiment is provided with only one of the positive terminal 5e3 and the negative terminal 5e4. The upper heater-connecting part 5e2 has electrical conductivity and is configured to allow electricity to flow from one to the other of the upper heater bodies 5e1. Thus, when electric power is supplied to the positive terminal 5e3 of the upper heater 5e, each of the upper heater bodies 5e1 can generate heat. The upper heater-connecting part 5e2 may be formed only of an electrically conductive material, or may have a structure in which an electrically conductive material (an electrical wire) is covered with an electrical insulation material.

Each upper end part of the lower heater body 5d1 and the upper heater body 5e1 is fixed to the supporting member 12, and thus the lower and upper heater bodies 5d1 and 5e1 are provided so as to extend downward from the supporting member 12. Since the length of the lower heater body 5d1 in the vertical direction is set to be greater than the length of the upper heater body 5e1 in the vertical direction, the lower end part of the lower heater body 5d1 is positioned below the lower end part of the upper heater body 5e1. That is, the lower heater-connecting part 5d2 is positioned below the upper heater-connecting part 5e2.

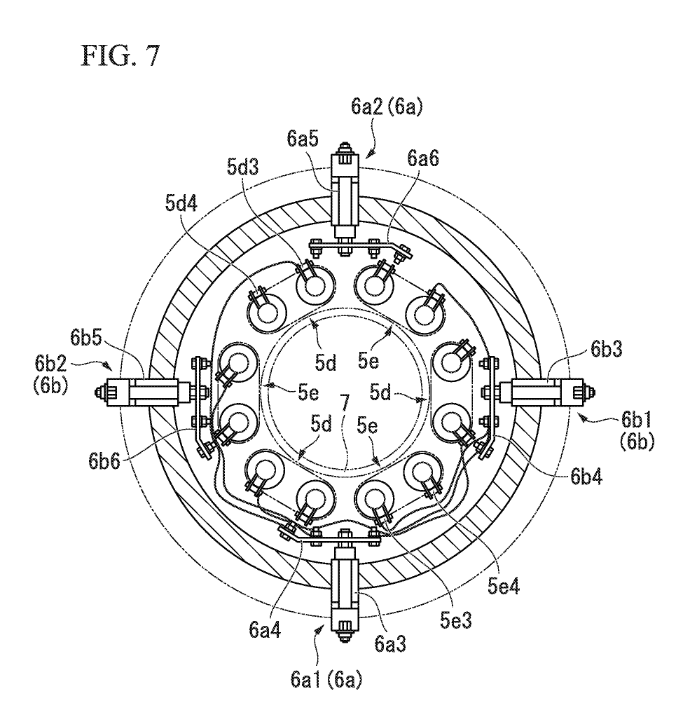

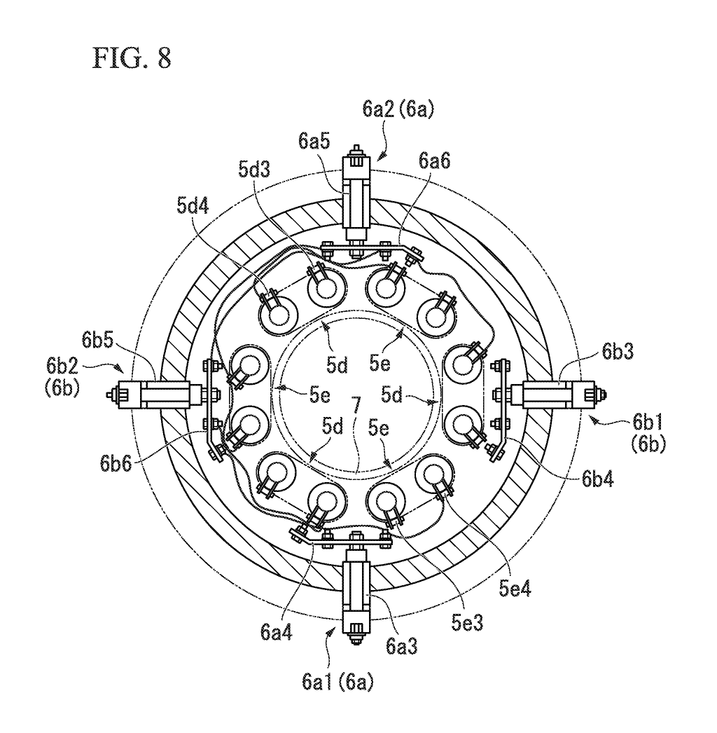

Each of FIGS. 7 and 8 is a view taken along B-B line in FIG. 5. It is to be noted that FIG. 7 shows a wire-connecting state between a wire-connecting entry-side section 6a1 of a lower heater-power supplier 6a and the lower heaters 5d through heat-resistant electrical wires and a wire-connecting state between a wire-connecting entry-side section 6b1 of an upper heater-power supplier 6b and the upper heaters 5e through heat-resistant electrical wires, and FIG. 8 shows a wire-connecting state between a wire-connecting exit-side section 6a2 of the lower heater-power supplier 6a and the lower heaters 5d through heat-resistant electrical wires and a wire-connecting state between a wire-connecting exit-side section 6b2 of the upper heater-power supplier 6b and the upper heaters 5e through heat-resistant electrical wires.

The heat treatment device 1A of this embodiment includes three lower heaters 5d and three upper heaters 5e. The heaters 5 (the lower and upper heaters 5d and 5e) are arranged in the circumferential direction of the heating chamber 2 (the side wall portion 2a). Additionally, in a pair of lower heater bodies 5d1, the lower heater bodies 5d1 are also arranged in the circumferential direction, and in a pair of upper heater bodies 5e1, the upper heater bodies 5e1 are also arranged in the circumferential direction.

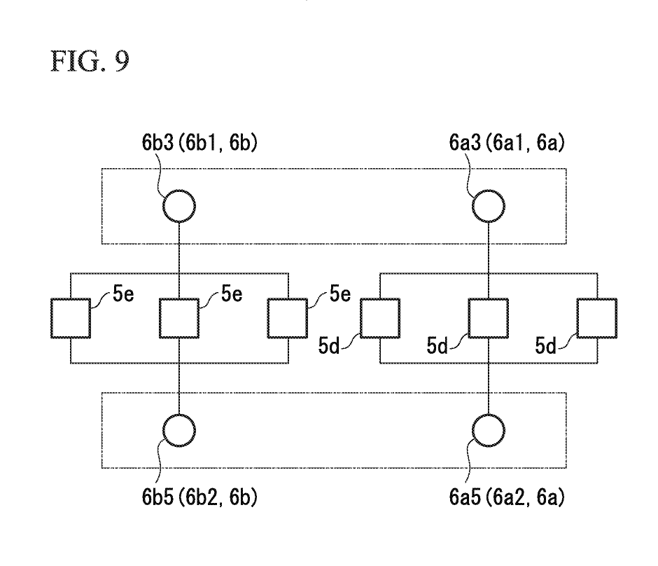

As shown in FIGS. 7 and 9, the wire-connecting entry-side section 6a1 of this embodiment includes one electrode bar 6a3 and one bus bar 6a4 electrically connected to the electrode bar 6a3. The bus bar 6a4 is connected to each of three positive terminals 5d3 of three lower heaters 5d (three pairs of lower heater bodies 5d1) through a heat-resistant electrical wire. That is, the bus bar 6a4 has three terminals to which three heat-resistant electrical wires are connected, and electrically connects the electrode bar 6a3 and these heat-resistant electrical wires. As shown in FIGS. 8 and 9, the wire-connecting exit-side section 6a2 of this embodiment includes one electrode bar 6a5 and one bus bar 6a6 electrically connected to the electrode bar 6a5. The bus bar 6a6 is connected to each of three negative terminals 5d4 of three lower heaters 5d (three pairs of lower heater bodies 5d1) through a heat-resistant electrical wire. That is, the bus bar 6a6 has three terminals to which three heat-resistant electrical wires are connected, and electrically connects the electrode bar 6a5 and these heat-resistant electrical wires.

As shown in FIGS. 7 and 9, the wire-connecting entry-side section 6b1 of this embodiment includes one electrode bar 6b3 and one bus bar 6b4 electrically connected to the electrode bar 6b3. The bus bar 6b4 is connected to each of three positive terminals 5e3 of three upper heaters 5e (three pairs of upper heater bodies 5e1) through a heat-resistant electrical wire. That is, the bus bar 6b4 has three terminals to which three heat-resistant electrical wires are connected, and electrically connects the electrode bar 6b3 and these heat-resistant electrical wires. As shown in FIGS. 8 and 9, the wire-connecting exit-side section 6b2 of this embodiment includes one electrode bar 6b5 and one bus bar 6b6 electrically connected to the electrode bar 6b5. The bus bar 6b6 is connected to each of three negative terminals 5e4 of three upper heaters 5e (three pairs of upper heater bodies 5e1) through a heat-resistant electrical wire. That is, the bus bar 6b6 has three terminals to which three heat-resistant electrical wires are connected, and electrically connects the electrode bar 6b5 and these heat-resistant electrical wires.

The electrode bars 6a3 and 6a5 may be connected with a power supply controller (a first power supply controller, not shown) that can output intended electric power, and thus the lower heater-power supplier 6a may be configured to supply electric power to the lower heaters 5d and to allow the lower heaters 5d to generate heat. The electrode bars 6b3 and 6b5 may be connected with a power supply controller (a second power supply controller, not shown) that can output intended electric power, and thus the upper heater-power supplier 6b may be configured to supply electric power to the upper heaters 5e and to allow the upper heaters 5e to generate heat.

The second embodiment can obtain all the effects shown in the above first embodiment. Additionally, in the second embodiment, since a heater-connecting part connects a pair of heater bodies to each other, one lower heater body 5d1 is provided with only one of the positive terminal 5d3 and the negative terminal 5d4, and one upper heater body 5e1 is provided with only one of the positive terminal 5e3 and the negative terminal 5e4. Thus, the number of heat-resistant electrical wires connecting electrode bars and lower and upper heaters can be ½ of that in the above first embodiment in which one heater body is provided with a positive terminal and a negative terminal. Since the number of electrical wires provided in a wiring space decreases, it is possible to sufficiently provide members or the like used for securing electrical insulation, and to easily secure electrical insulation between heat-resistant electrical wires. In addition, since the number of provided electrical wires decreases, it is possible to reduce both of the material cost and the wiring work cost. Furthermore, since a heater-connecting part connects a pair of heater bodies to each other, it is possible to improve the rigidity of one heater including a pair of heater bodies and to prevent breakage of the heater during maintenance or the like.

The positional relationship between an electrode bar and a bus bar of the second embodiment is the reverse of that of the above first embodiment, and the bus bar of the second embodiment is used for connecting one electrode bar and a plurality of heat-resistant electrical wires connected to heaters. Therefore, it is possible to reduce the number of electrode bars compared to that in the above first embodiment.

Hereinbefore, although suitable embodiments are described with reference to the drawings, the present disclosure is not limited to the above embodiments. The shape, the combination or the like of each component shown in the above embodiments is an example, and addition, omission, replacement, and other modifications of a configuration based on a design request or the like can be adopted within the scope of the present disclosure.

For example, in the above first embodiment, a configuration is described in which each of the numbers of the lower heaters 5a and the upper heaters 5b is six. However, the present disclosure is not limited thereto, and the installed numbers of the lower heaters 5a and the upper heaters 5b may be changed. In a case where the quantities of heat generation demanded of the lower heaters and the upper heaters are different, the heat generation performances of the lower heater and the upper heater may be set to be different, or the installed numbers of the lower heaters and the upper heaters may be set to be different. In a case where the installed numbers are set to be different, for example, it is conceivable that two lower heaters and one upper heater are alternately arranged in the circumferential direction. In addition, the lower heaters 5a and the upper heaters 5b need not be alternately arranged at regular intervals. In the above second embodiment, the installed numbers or the heat generation performances of the lower heaters 5d and the upper heaters 5e may also be changed.

In the above embodiments, the lower and upper heaters are fixed to the supporting member 12 provided in the upper section of the heating chamber 2. However, in view of an object to prevent non-uniformity in temperature between the upper section of the lower section of the heating chamber 2, the supporting member may be disposed in the lower section of the heating chamber, and the lower and upper heaters may be provided so as to extend upward from the supporting member. In this case, the length of the lower heater is set to be less than that of the upper heater.

Although the positional relationships between the electrode bar and the bus bar of the first and second embodiments are the reverse to each other, the configuration of the electrode bar and the bus bar of the first embodiment may be applied to the second embodiment, or the configuration of the electrode bar and the bus bar of the second embodiment may be applied to the first embodiment.

Although the lower and upper heaters that are electric heaters are employed in the above embodiments, the present disclosure is not limited thereto, and for example, heaters (burners) using combustion heat of combustion gas may be employed for the lower and upper heaters of the present disclosure.

In the above embodiments, although the heating chamber 2 and the thermal insulator 3 are formed into cylindrical shapes, the present disclosure is not limited thereto, and each thereof may be formed into a shape other than a cylindrical shape, for example, into a square tube shape.

In the above embodiments, an example is described in which the features shown in the claims of the present application are applied to the heat treatment device 1. However, the present disclosure is not limited to the above embodiments, and the features can be applied to a vacuum-carburizing furnace or the like.

### INDUSTRIAL APPLICABILITY

The present disclosure can be used for a heat treatment device that performs heating treatment for a treatment object inside a heating chamber including a heater.

1. A heat treatment device for performing heating treatment for a treatment object, the heat treatment device comprising:
a heating chamber inside which a treatment object is contained;
lower heaters that are electric heaters and heat a lower section of a receiving area that is an area inside the heating chamber in which the treatment object is contained;
upper heaters that are electric heaters and heat an upper section of the receiving area;
a thermal conduction barrier wall disposed between the receiving area and the lower and upper heaters;
an upper heater-power supplier that supplies electric power to all the upper heaters; and
a lower heater-power supplier that supplies electric power to all the lower heaters.

2. A heat treatment device for performing heating treatment for a treatment object, the heat treatment device comprising:
a heating chamber inside which a treatment object is contained;
a lower heater that heats a lower section of a receiving area that is an area inside the heating chamber in which the treatment object is contained;
an upper heater that heats an upper section of the receiving area; and
a thermal conduction barrier wall disposed between the receiving area and the lower and upper heaters;
wherein the lower heater comprises:
a pair of lower heater bodies extending in a vertical direction, and
a lower heater-connecting part connecting end parts of the lower heater bodies to each other, and
wherein the upper heater comprises:
a pair of upper heater bodies extending in the vertical direction, and
an upper heater-connecting part connecting end parts of the upper heater bodies to each other.

3. The heat treatment device according to claim 2,
wherein the lower and upper heaters are electric heaters,
wherein the lower heater-connecting part has electrical conductivity and is configured to allow electricity to flow from one to the other of the lower heater bodies, and the upper heater-connecting part has electrical conductivity and is configured to allow electricity to flow from one to the other of the upper heater bodies,
wherein one of the lower heater bodies is provided with an entry-side terminal for electric power, and the other of the lower heater bodies is provided with an exit-side terminal for electric power, and
wherein one of the upper heater bodies is provided with an entry-side terminal for electric power, and the other of the upper heater bodies is provided with an exit-side terminal for electric power.
